(19) United States
(12) Patent Application Publication
(10) Pub. No.: US 2016/0315835 A1
(43) Pub. Date: Oct. 27, 2016

(54) TRACKING CONTENT SHARING ACROSS A VARIETY OF COMMUNICATIONS CHANNELS

(71) Applicant: INTERNATIONAL BUSINESS MACHINES CORPORATION, Armonk, NY (US)

(72) Inventors: JONATHAN F. BRUNN, LOGAN, UT (US); JEFFREY R. HOY, SOUTHERN PINES, NC (US); MARIT L. IMSDAHL, MORRISVILLE, NC (US); ASIMA SILVA, HOLDEN, MA (US)

(21) Appl. No.: 15/181,487

(22) Filed: Jun. 14, 2016

Related U.S. Application Data
(63) Continuation of application No. 14/696,516, filed on Apr. 27, 2015.

(51) Int. Cl. H04L 12/26; H04L 29/08; H04L 29/06

(52) U.S. Cl. CPC H04L 43/06; H04L 67/42; H04L 67/22; H04L 67/06

(57) ABSTRACT

Embodiments include methods, systems and computer program products for tracking content sharing across multiple channels. Aspects include receiving, by a content server, a request for a piece of content from a user and determining if the request includes a view identifier that is associated with the user. Based on determining that the request does not include the view identifier that is associated with the user, aspects also include generating a new view identifier for the user and storing information about the user and the new view identifier and providing the requested piece of content to the user and providing an updated URL including the new view identifier to the user.

### DOMESTIC PRIORITY

This application is a continuation application of the legally related U.S. Ser. No. 14/696,516, filed Apr. 27, 2015, the contents of which are incorporated by reference herein in their entirety.

### BACKGROUND

The present disclosure relates to tracking content sharing amongst individuals, and more particularly, to a method, system and computer program product for tracking content sharing across a variety of communications channels.

The proliferation of communications channels, such as social networks, email, texting, instant messaging, etc. has increased the difficulty of tracking the propagation of shared content amongst individuals. Existing solutions to track sharing across multiple communications channels rely on the use of channel identifiers in uniform resource locators (URLs) or using unique shortened URLs. In some current systems, shortened URLs are used and user information is captured when the shortened URL is viewed (or resolved). Combining that information with sharing information from social networks can provide some information regarding the sharing history of a piece of content.

In current systems, once the user has opened a webpage via a shortened URL and copies the standard URL to which the short URL redirects, the subsequent sharing of that webpage can be difficult to trace back to the original share, or shortened URL. In other words, if the user simply copies the URL from their browser instead of using the shortened URL and then shares the standard URL using a channel of sharing such as email or instant message from which no public data feed is available for analysis, the sharing graph may be incomplete.

### SUMMARY

In accordance with an embodiment, a method for tracking content sharing across multiple channels includes receiving, by a content server, a request for a piece of content from a user and determining if the request includes a view identifier that is associated with the user. Based on determining that the request does not include the view identifier that is associated with the user, the method also includes generating a new view identifier for the user and storing information about the user and the new view identifier and providing the requested piece of content to the user and providing an updated URL including the new view identifier to the user.

In accordance with another embodiment, a computer system for tracking content sharing across multiple channels includes a processor that is configured to perform a method that includes receiving, by a content server, a request for a piece of content from a user and determining if the request includes a view identifier that is associated with the user. Based on determining that the request does not include the view identifier that is associated with the user, the method also includes generating a new view identifier for the user and storing information about the user and the new view identifier and providing the requested piece of content to the user and providing an updated URL including the new view identifier to the user.

In accordance with a further embodiment, a computer program product for tracking content sharing across multiple channels includes a non-transitory storage medium readable by a processing circuit and storing instructions for execution by the processing circuit for performing a method. The method includes receiving, by a content server, a request for a piece of content from a user and determining if the request includes a view identifier that is associated with the user. Based on determining that the request does not include the view identifier that is associated with the user, the method also includes generating a new view identifier for the user and storing information about the user and the new view identifier and providing the requested piece of content to the user and providing an updated URL including the new view identifier to the user.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram illustrating one example of a processing system for practice of the teachings herein;

FIG. 2 is a block diagram illustrating one example of a content sharing environment in accordance with an exemplary embodiment;

FIG. 3 is a flow diagram of a method for generating URLs with a view identifier in accordance with an exemplary embodiment; and

FIG. 4 is a flow diagram of a method for tracking content sharing across multiple communications channels in accordance with an exemplary embodiment.

### DETAILED DESCRIPTION

In accordance with exemplary embodiments of the disclosure, methods, systems and computer program products for tracking content sharing across multiple communications channels are provided. In exemplary embodiments, the URL of a webpage, or piece of content, is altered as the content is loaded to generate a view identifier that is embedded in the URL for each new page view. In exemplary embodiments, the view identifier is configured to be unique for each viewer of the content. For example, if a user repeatedly accesses the content, the view identifier will remain the same. In addition, in exemplary embodiments the URLs are configured such that users are prevented from altering the URL to remove the view identifier from the URL and still be able to access the content.

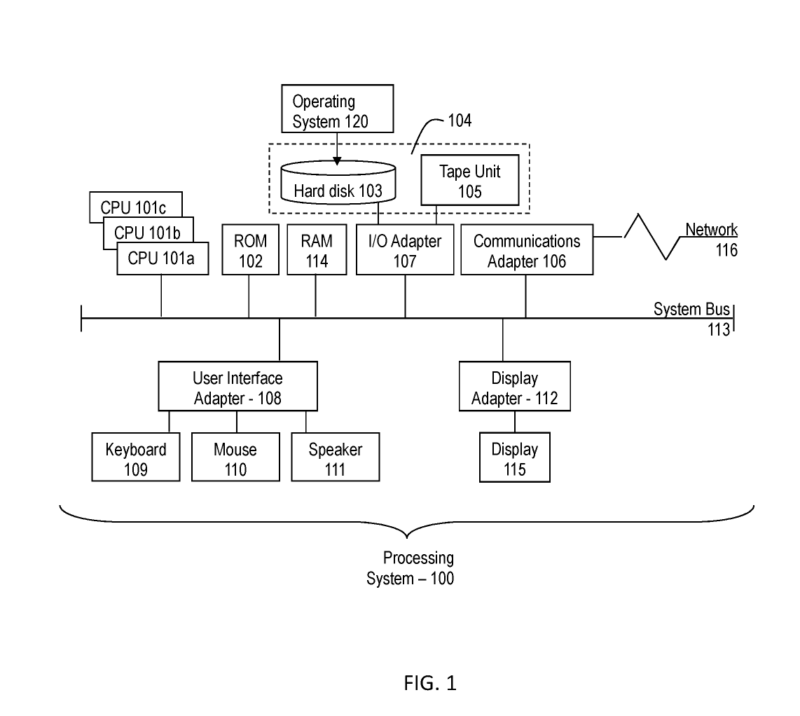

Referring to FIG. 1, there is shown an embodiment of a processing system 100 for implementing the teachings herein. In this embodiment, the system 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 114 and various other components via a system bus 113. Read only memory (ROM) 102 is coupled to the system bus 113 and may include a basic input/output system (BIOS), which controls certain basic functions of system 100.

FIG. 1 further depicts an input/output (I/O) adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. Operating system 120 for execution on the processing system 100 may be stored in mass storage 104. A network adapter 106 interconnects bus 113 with an outside network 116 enabling data processing system 100 to communicate with other such systems. A screen (e.g., a display monitor) 115 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

Thus, as configured in FIG. 1, the system 100 includes processing capability in the form of processors 101, storage capability including system memory 114 and mass storage 104, input means such as keyboard 109 and mouse 110, and output capability including speaker 111 and display 115. In one embodiment, a portion of system memory 114 and mass storage 104 collectively store an operating system such as the AIX® operating system from IBM Corporation to coordinate the functions of the various components shown in FIG. 1.

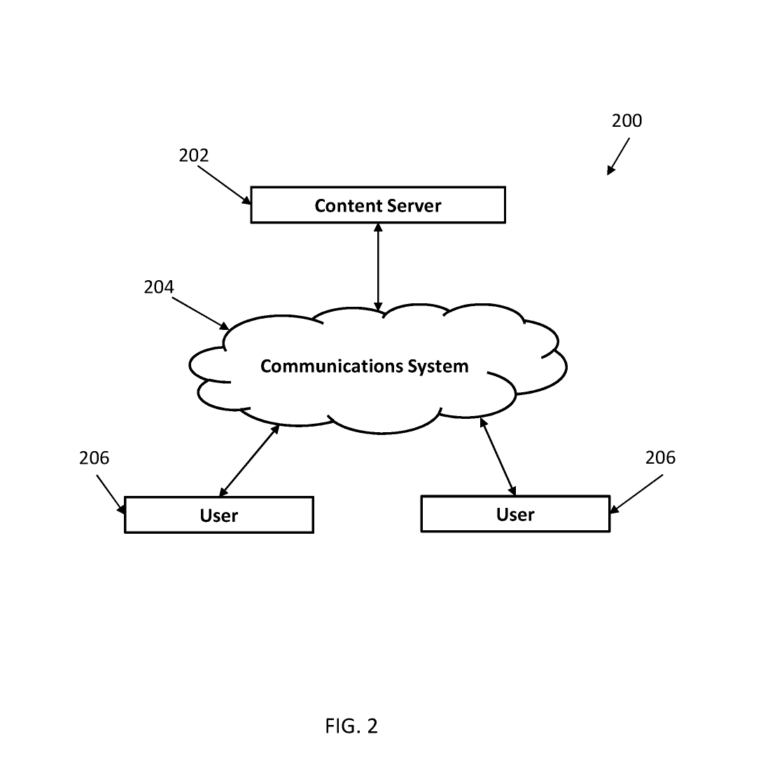

Referring to FIG. 2, a block diagram illustrating one example of a content sharing environment 200 in accordance with an exemplary embodiment is shown. As illustrated, the content sharing environment 200 includes a content server 202 that is accessible to one or more users 206 via a communications system 204. The content server 202 is a webserver that is configured to host and provide content and that is configured to generate URLs having view identifiers for the hosted content. The webserver may be a processing system similar to the one depicted in FIG. 1. In exemplary embodiments, the one or more users 206 may utilize any of a wide variety of devices to access the content server, such devices may include, but are not limited to, a smartphone, a laptop, a tablet, a personal computer, or the like. The communications system 204 includes any means of electronically sharing content between two users. For example, the communications system 204 may include, but is not limited to, the Internet, social networks, email servers, cellular networks, instant messaging servers, and the like.

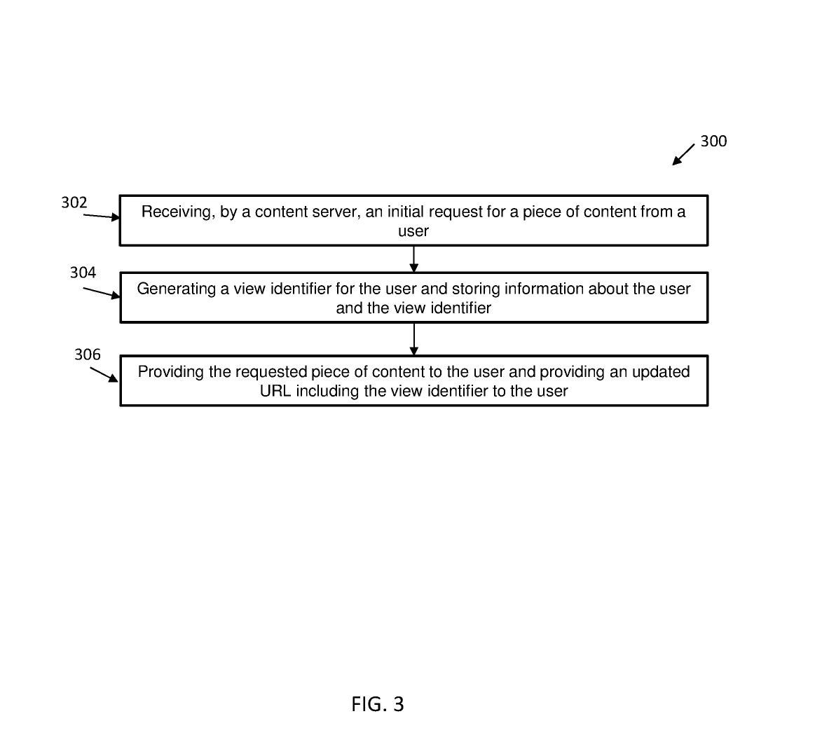

Referring now to FIG. 3, a flow diagram of a method 300 for generating URLs with a view identifier in accordance with an exemplary embodiment is shown. As shown at block 302, the method 300 includes receiving, by a content server, an initial request for a piece of content. In exemplary embodiments, the initial request for a piece of content may be generated in any of wide variety of way. For example, the user may find a link to the content in response to a search request on a searching engine. In another example, the user may follow a link to the content from a website, email, QR code, or the like. Next, as shown at block 304, the method 300 includes generating a view identifier for the user and storing information about the user and the view identifier. In exemplary embodiments, HTML 5 history APIs or existing URL fragment modification can be used to modify the URL of the requested content to include the view identifier, or view ID. For instance, a URL such as http://example.com/article may be modified to become http://example.com/article/<viewId> upon loading of the initial page. In exemplary embodiments, the view IDs may be any alphanumeric sequence and do not need to be sequential. In exemplary embodiments, the view ID is stored by the content server with as much information as can be discerned from the user, including the referrer and any cookies to identify the user.

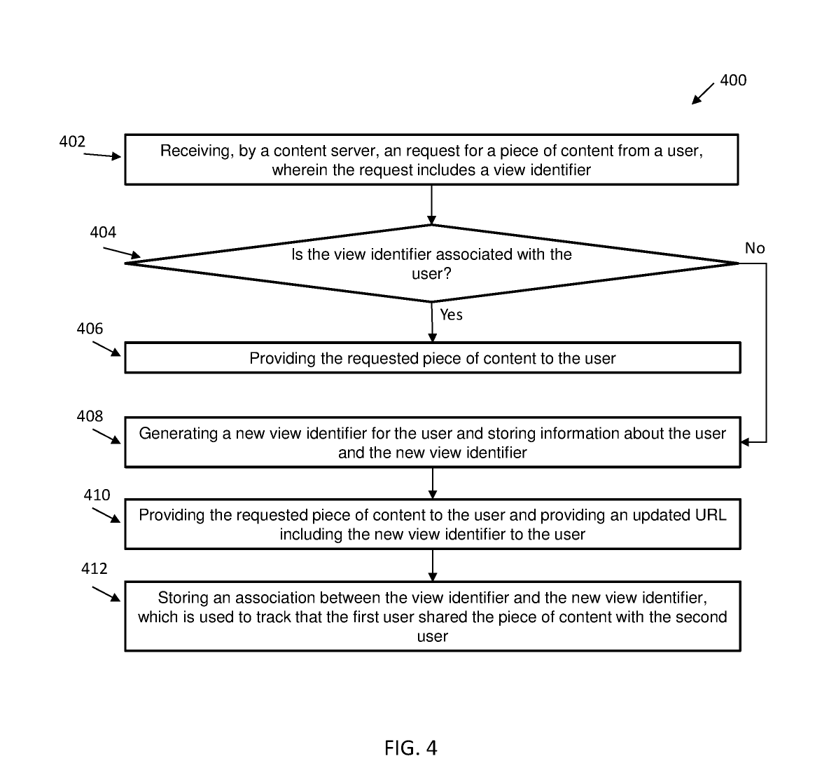

Referring now to FIG. 4, a flow diagram of a method 400 for tracking content sharing across multiple communications channels in accordance with an exemplary embodiment is shown. As shown at block 402, the method 400 includes receiving, by a content server, a request for a piece of content from a user, wherein the request includes a view identifier. Next, as shown at decision block 404, the method 400 includes determining if the view identifier provided is associated with the user. In other words, is this a new viewer of the content or a returning viewer. If the view identifier provided is associated with the user, the method 400 proceeds to block 406 and includes providing the requested piece of content to the user. Otherwise, the method 400 proceeds to block 408 and includes generating a new view identifier for the user and storing information about the user and the new view identifier. Next, as shown at block 410, the method 400 includes providing the requested piece of content to the user and providing an updated URL including the new view identifier to the user. The method 400 also includes storing an association between the view identifier and the new view identifier, which is used to track that the first user shared the piece of content with the second user, as shown at block 410. In exemplary embodiments, the method may also include creating a sharing graph based on the stored associations of the view identifiers.

In one example, an article that is first accessed from a link in a search index has a URL of http://example.com/article. When the article is opened by a first user, the content server changes the URL provided to the first user to be http://example.com/article/viewer#1. When the first user decides to share the article with a second user by copying and emailing the URL from their web browser, the first user will copy the URL including the view ID. Next, when the second user opens the link provided by user 1, and the content server will check to see if the second user is the first user and upon determining that the second user is distinct from the first user, the content server changes the URL to http://example.com/article/viewer#2. In exemplary embodiments, the content server may use any of a variety of known techniques to determine if the second user is distinct from the first user. In exemplary embodiments, a history API on the content server may be used to update the URL provided to viewer 2. In addition, the content server stores an indication that view ID “viewer#1” resulted in views ID “viewer#2.” As the second user forwards the article (perhaps over a new channel such as a text message or social media post), the view IDs are once again changed for the next viewers of the article.

In exemplary embodiments, each time a piece of content is viewed by a new viewer, the content server will change the URL provided to the viewer. Each unique page view is therefore given a unique ID, without causing a page refresh, and these view IDs can be used to track sharing through a variety of communications channels. In exemplary embodiments, the content server may distinguish page refreshes, or subsequent accesses by a single user, through the use of a session cookie or local browser storage containing the view ID in order to avoid the creation of a new view ID.

In exemplary embodiments, the content server is configured to store a record of how information propagates through all manners of sharing. The content server can make use of a hashed URL or fragment identifier as in http://example.com/article#3. In this case the background request from the page contains enough information not only to associate the old and new view IDs, but to record the view action on the old ID.

In exemplary embodiments, the content server is configured to prevent the user from removing the view ID from the URL prior to sharing the URL, which would result in the content server losing the ability to track the chain of sharing. For example, the content server may prevent a requested page content from loading without a proper view ID being present in the URL, which is verified with the content server. In such a system, the only way for a user to obtain a view ID is to open the page with an existing view ID, which will create the association between the old and view ID, making all shares and content views tracked across all sharing platforms.

In exemplary embodiments, the content server may take additional steps to automatically rewrite an original URL into the updated URL, to the extent supported or allowed by the browsing environment of the user. In one example, when a user visits a web page that updates its URL, if the web browser has access to the system copy/paste buffer and the buffer contains the target URL, the web browser may be configured to automatically update the URL stored in the buffer with the updated URL.

In another example, a web browser or mobile application may be configured to register the rewritten URL with the system. Accordingly, when the user runs across the original URL, for example by pasting the URL into an email, the system may automatically rewrite the pasted URL into the updated version of the URL. In exemplary embodiments, the system may identify these URLs through copy/paste analysis or data file analysis or displayed text analysis.

In a further example, when loading content with URLs, such as documents with active links, the system can check those links to see if they trigger an update (perhaps through a whitelist of supported domains). The system can then save the updated URL in updated versions of the document.

As will be appreciated by those of ordinary skill in the art the invention may be found in a content management system, especially a web content management system, as a part of a content site itself, or as a part of a content distribution network which has the opportunity to respond to URLs with cached content, thereby inserting logic into the rendering of a page, recording statistics and keeping the necessary database of view IDs and user information required for the invention. In addition, the invention could also be an add-on to a content site provided by a social network. In this case, the invention would be implemented by the social network itself but exposed through the content site.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for tracking content sharing across multiple channels, the method comprising:
receiving, by a content server, a request for a piece of content from a user;
determining if the request includes a view identifier that is associated with the user; and
based on determining that the request does not include the view identifier that is associated with the user:
generating a new view identifier for the user and storing information about the user and the new view identifier; and
providing the requested piece of content to the user and providing an updated URL including the new view identifier to the user.

2. The method of claim 1 further comprising based on determining that the request does not include the view identifier that is associated with the user, storing an association between the view identifier and the new view identifier, which is used to indicate that the first user shared the piece of content with the second user.

3. The method of claim 1 further comprising based on determining that the request includes the view identifier that is associated with the user, providing the requested piece of content to the user.

4. The method of claim 1 further comprising based on determining that the request does not include a valid view identifier, denying access to the requested piece of content to the user.

5. The method of claim 1 further comprising based on determining that the request does not include a valid view identifier:
generating a new view identifier for the user and storing information about the user and the new view identifier; and
providing the requested piece of content to the user and providing an updated URL including the new view identifier to the user.

6. The method of claim 2, further comprising creating a sharing graph based on the association between stored view identifiers.
